(19) United States
(12) Patent Application Publication
(10) Pub. No.: US 2023/0011995 A1
(43) Pub. Date: Jan. 12, 2023

(54) METHOD FOR REGULATING A HEATER AND THE HEATER

(71) Applicant: Mahle International GmbH, Stuttgart (DE)

(72) Inventors: Josep Rosell Carbonell, Algemesi (ES); Guillaume Daudon, La Bourgonce (FR); Christina Valiente Espi, Algemesi (ES); Juan Sastre Garulo, Valencia (ES); Kevin Carcel Gimenez, Algemesi (ES); Javier Gallego Iglesias, Valencia (ES); Jean-Francois Walter, Turckheim (FR)

(21) Appl. No.: 17/860,103

(22) Filed: Jul. 8, 2022

(30) Foreign Application Priority Data
Jul. 8, 2021 (DE) 102021207253.4

(51) Int. Cl. G05D 23/24; H05B 1/02

(52) U.S. Cl. CPC G05D 23/2401; H05B 1/023; B60L 58/27

(57) ABSTRACT

A method for regulating a heater including at least one heating element having a temperature-dependent electrical resistance is disclosed. The method may include determining, with a regulating unit of the heater, a current heating behaviour of the heating element based on a time profile of the resistance of the heating element. The heating element may exhibit (i) an NTC heating behaviour at temperatures below a transition temperature, (ii) a PTC heating behaviour at temperatures above the transition temperature, and (iii) a transition between the NTC heating behaviour and the PTC heating behaviour at the transition temperature and a resistance minimum. The method may further include determining, with the regulating unit, at least one input parameter for the heating element based on the current heating behaviour. The method may also include regulating, with the regulating unit, the heating element via the at least one input parameter.

### CROSS-REFERENCE TO RELATED APPLICATIONS

This application claims priority to German Patent Application No. DE 10 2021 207 253.4, filed on Jul. 8, 2021, the contents of which is hereby incorporated by reference in its entirety.

### TECHNICAL FIELD

The invention relates to a method for regulating a heater having at least one heating element with a temperature-dependent electrical resistance. The invention also relates to a heater having at least one heating element.

### BACKGROUND

Generic electric heaters are already known from the prior art. There, the heater comprises at least one heating element with a temperature-dependent resistance, a so-called PTC thermistor. For example, EP 2 075 452 A2 discloses an electric heater having multiple PTC thermistors for heating fuel in a motor vehicle. EP 2 732 995 A1 discloses an electric heater having multiple PTC thermistors for heating air in a motor vehicle.

There, the heating element or the PTC thermistor has a positive temperature coefficient or a PTC heating behaviour between a transition temperature and the Curie temperature. Up to the transition temperature and from the Curie temperature, the heating element or the PTC thermistor has a negative temperature coefficient or an NTC heating behaviour. There, the regulating of the heating element takes place in a part range of the positive temperature coefficient. In the process, the current temperature of the heating element or the PTC thermistor is determined and the heating element or the PTC thermistor brought to the required temperature and thus the required heating output by the adaptation of input parameters such as current and voltage.

From the resistance of the heating element or of the PTC thermistor alone the current temperature of the heating element or of the PTC thermistor cannot however be safely determined since the same resistance value can be present at deviating temperatures. These different temperatures are assigned on the one hand to the NTC heating behaviour and on the other hand to the PTC heating behaviour, during which the behaviour of the heating element or of the PTC thermistor deviates. The change between the PTC heating behaviour and the NTC heating behaviour can occur in an uncontrolled manner through a change of the fluid flow or the ambient temperature. In order to sense the temperature of the heater independently of the resistance and be able to safely regulate the heater, temperature sensors are usually installed in the heater. Disadvantageously, the costs of the heater are increased because of this.

### SUMMARY

The object of the invention therefore is to provide an improved or at least alternative method for regulating a heater having at least one heating element and the suitably adapted improved or at least alternative heater. In particular, the described disadvantages are to be overcome with the method and with the heater.

According to the invention, this object is solved through the subject matter of the independent claim(s). Advantageous embodiments are the subject matter of the dependent claim(s).

A method is provided for regulating a heater having at least one heating element which has a temperature-dependent electrical resistance. At a transition temperature and a resistance minimum the at least one heating element exhibits a transition between an NTC heating behaviour and a PTC heating behaviour. There, the at least one heating element exhibits the NTC heating behaviour below the transition temperature and the PTC heating behaviour above the transition temperature. According to the invention, a regulating unit of the heater determines in a check the current heating behaviour of the at least one heating element based on a time profile of the resistance of the at least one heating element. Dependent on the determined current heating behaviour, the regulating unit in a determination step determines at least one input parameter for the at least one heating element. The at least one input parameter is preferentially current and/or voltage. In a regulating step, the regulating unit now regulates the at least one heating element via the at least one input parameter.

During the NTC heating behaviour (NTC: negative temperature coefficient), the at least one heating element has a negative temperature coefficient and the resistance of the at least one heating element falls with the rising temperature. During the PTC heating behaviour (PTC: positive temperature coefficient), the at least one heating element has a positive temperature coefficient and the resistance of the at least one heating element increases with the rising temperature. The heating element is a PTC thermistor and can in particular be a ceramic PTC thermistor. In the regulating step, the regulating unit regulates the at least one heating element in that it adjusts the at least one parameter on the at least one heating element. Here, the at least one heating element of the heater is preferentially regulated via the input parameters current and voltage. Preferentially, a constant working voltage and a variable average current based on the applied duty cycle of the PWM-signal (PWM: Pulse-Wight-Modulation) are applied to the at least one heating element. Preferentially, the duty cycle of the PWM-signal is thus determined in the determination step. As a result of the variating in duty cycle of the PWM-signal, the time in which current is being applied to the at least one heating element varies. In other words, the percentage of duty cycle of the PWM-signal being applied determines the percentage of time where current is being applied to the at least one heating element.

As distinct from conventional regulating methods, the current heating behaviour, in the method according to the invention is determined based on the time profile of the resistance during the check. Once the current heating behaviour is determined, the current temperature can also be safely determined from the resistance. Advantageously, the temperature sensors which are conventionally necessary for determining the current temperature of the at least one heating element are no longer required. By way of this, the costs of the heater can be advantageously reduced.

Advantageously, it can be provided in the method that the regulating unit regulates the at least one heating element currently exhibiting the PTC heating behaviour in the regulating step via the at least one input parameter to the required heating output. In other words, the required heating output on the at least one heating element is exclusively adjusted during the PTC heating behaviour.

Advantageously, it can be provided in the method that the regulating unit in the regulating step maximally regulates the at least one heating element currently exhibiting the PTC heating behaviour to a maximum output. Here, the maximum output is defined at a threshold resistance which correlates to a threshold temperature. The threshold resistance can be advantageously an equilibrium value between a maximum heating output and an optimum temperature. The threshold resistance depends on the characteristics of the heating element and can be defined experimentally or theoretically. The threshold temperature correlating to the threshold resistance is smaller than the Curie temperature of the at least one heating element and greater than the transition temperature of the at least one heating element. In other words, the temperature of the at least one heating element is always below the Curie temperature. Thus, the at least one heating element in the method never reaches the Curie temperature, so that the overheating protection can be realised at a temperature that is lower than the Curie temperature. By way of this, powerful heating elements can be used in the heater regardless of their Curie temperature.

Advantageously it can be provided in the method that the regulating unit after the check verifies the state of the at least one heating element in a safeguarding step. When the at least one heating element has a temperature above a threshold temperature and the temperature cannot be reduced in the regulating step, the regulating unit discontinues regulating and interrupts the energy supply of the heating element. In other words, when the at least one heating element has a temperature above the threshold temperature and the reducing of the duty cycle of the PWM-signal for the current do not lead to reducing of the temperature, the regulating unit discontinues regulating and interrupts the energy supply of the heating element. By way of this—as already explained above—the overheating protection in the at least one heating element can be solely realised by way of the method. Because of this, powerful heating elements regardless of their Curie temperature can be used in the heater. Advantageously, the interruption of the energy supply can be started again after a defined time interval—for example 30 seconds.

Advantageously it can be provided in the method that the regulating unit during the check, checks in an establishment step the time profile of the resistance of the at least one heating element. In the process, the regulating unit searches for a behaviour that can be interpreted as transition between the NTC heating behaviour and the PTC heating behaviour in the at least one heating element. When the searched behaviour is present, the regulating unit determines the current heating behaviour of the at least one heating element in a verification step. Thereafter, the regulating unit in the determination step determines, dependent on the current heating behaviour, the at least one input parameter for the at least one heating element. When however the searched behaviour is not present, the transition between the NTC heating behaviour and the PTC heating behaviour is not occurred and the heating element has still the same i.e. previously detected heating behaviour. In this case, the regulating unit proceeds to the determination step and determines in the determination step the at least one input parameter for the at least one heating element based on the same i.e. previously detected heating behaviour.

When the at least one heating element changes from the NTC heating behaviour into the PTC heating behaviour or out of the PTC heating behaviour into the NTC heating behaviour, the resistance of the at least one heating element drops to the resistance minimum and subsequently rises. The change of the current correlating to this can be established by the regulating unit during the establishment step. On the other hand, the resistance of the at least one heating element can also fall or rise due to the surroundings—for example through a change of the fluid flow. Accordingly, the resistance of the PTC heating behaviour increases during environmental heating of the at least one heating element and during the NTC heating behaviour upon environmental cooling of the at least one heating element. In order to exclude environmental errors, the regulating unit verifies in the verification step the heating behaviour that is currently present and thus indirectly whether the behaviour determined during the establishment step was in fact a transition.

Advantageously it can be provided in the method that the regulating unit during the establishment step measures the current on the at least one heating element within a predetermined time window. Then, the regulating unit increases a counter while measuring the current when the currently measured current value is higher than all previously measured current values. When the counter exceeds a predefined counter threshold value, the regulating unit establishes this as a behaviour to be interpreted as transition.

In order to determine the current heating behaviour or in order to ensure the transition on the at least one heating element, the regulating unit during the verification step can increase the duty cycle of the PWM-signal for an initial current currently applied to the at least one heating element for a predetermined time interval by a predefined value and senses the change of the current of the at least one heating element. In addition, the regulating unit during the verification step can reduce the duty cycle of the PWM-signal for an initial current currently applied to the at least one heating element for a predetermined time interval by a predetermined value and sense the change of the current of the at least one heating element. The increasing and reducing of the duty cycle of the PWM-signal for the initial current can advantageously take place directly one after the other wherein the sequence is not decisive. Preferentially, the regulating unit increases and reduces the duty cycle of the PWM-signal for the initial current by 10% in each case. However, other values are also conceivable.

Based on the change of the resistance calculated from the sensed current of the at least one heating element, the regulating unit during the verification step can now determine the current heating behaviour. In the process, the regulating unit determines the current heating behaviour as PTC heating behaviour when during the increase of the duty cycle of the PWM-signal for the current the resistance calculated from the sensed current increases and during the reduction of the duty cycle of the PWM-signal for the current the resistance calculated from the sensed current falls. Accordingly, the regulating unit during the verification step determines the current heating behaviour as NTC heating behaviour when during the increase of the duty cycle of the PWM-signal for the current the resistance calculated from the sensed current falls and during the reduction of the duty cycle of the PWM-signal for the current the resistance calculated from the sensed current rises. However, the current heating behaviour cannot be unambiguously determined when the resistance during the increase and the reduction of the duty cycle of the PWM-signal for the current falls in each case and during the increase and the reduction of the duty cycle of the PWM-signal for the current rises in each case.

When the regulating unit was not able to determine the current heating behaviour, it can be provided in the method that the regulating unit repeats the verification step. On repeating the verification step, the regulating unit increases and reduces the duty cycle of the PWM-signal for an initial current currently applied to the at least one heating element for the predetermined time interval by a predefined value. This value is preferentially higher than the predefined value during the previously performed verification step. Preferentially, the regulating unit increases and reduces the duty cycle of the PWM-signal for the initial current by 20% in each case. However, other values are also conceivable. Here, the increase and the reduction of the duty cycle of the PWM-signal for the initial current can also take place directly one after the other, wherein the sequence is not decisive.

Advantageously it can be provided in the method that the regulating unit during the verification step determines the rising and the falling of the resistance of the at least one heating element by way of a ramp determination. Advantageously, the regulating unit during the verification step can determine the resistance minimum of the at least one heating element.

The invention also relates to a heater having at least one heating element. There, the at least one heating element has a temperature-dependent electrical resistance. The at least one heating element exhibits a transition between an NTC heating behaviour and a PTC heating behaviour at a transition temperature and a resistance minimum. There, the at least one heating element exhibits the NTC heating behaviour below the transition temperature and the PTC heating behaviour above the transition temperature. Furthermore, the heater comprises a regulating unit which is designed for carrying out the method described above. Advantageously, the heater can be provided for a battery-electric motor vehicle.

Advantageously, the heater can be incorporated in an electrical switching circuit which then comprises an energy source—for example a traction battery of the battery-operated motor vehicle—for supplying the heater with current and voltage and comprises the heater. Advantageously, the regulating unit of the heater can then comprise a micro controller and a switch for interrupting the switching circuit. There, the micro controller can generate a square-wave signal of variable width after the switch is opened and closed and thus the switching circuit interrupted or restored. By way of this, the duty cycle of the PWM-signal for the current flowing to the at least one heating element can be varied and the at least one heating element regulated. Here, the heating element is a PTC thermistor and can in particular be a ceramic PTC thermistor. In addition, the micro controller can read out the current and/or the voltage on the at least one heating element. This information can be used for regulating the at least one heating element to the required output. Furthermore, this information can be used for calculating the resistance of the at least one heating element.

In order to avoid repetitions, reference is made here to the above explanations.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIG. 1 shows a view of a switching circuit with a heater according to the invention;

FIG. 2 shows a temperature-resistance characteristic curve of a heating element with a temperature-dependent resistance;

FIG. 3 shows a diagram of a method according to the invention for regulating the heater according to the invention;

FIG. 4 shows an illustration of an establishment step of the method according to the invention;

FIG. 5 shows an illustration of a verification step of the method according to the invention.

### DETAILED DESCRIPTION

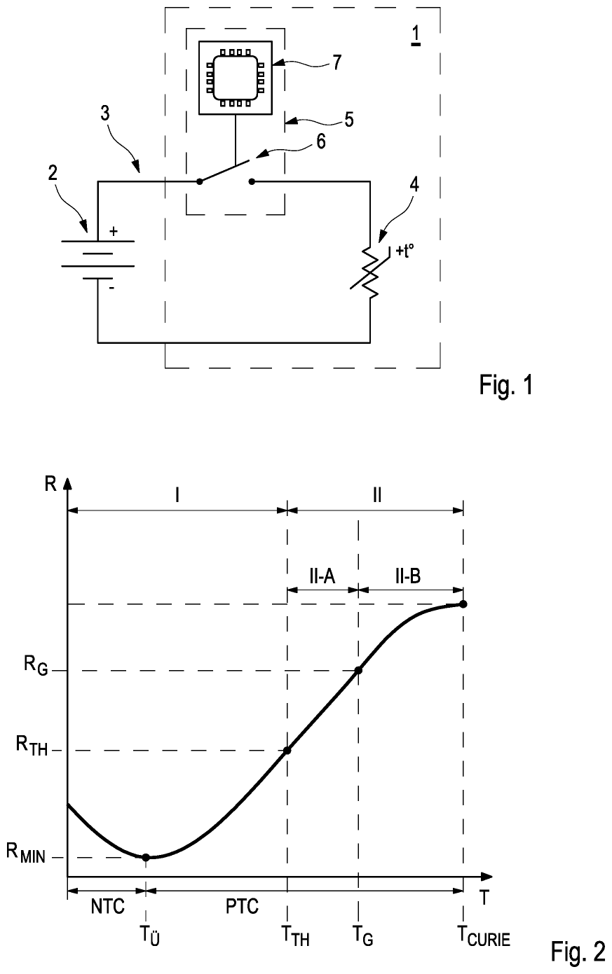

FIG. 1 shows a view of a heater 1 according to the invention and an energy source 2, which are electrically interconnected into a switching circuit 3. Advantageously, the heater 1 can be provided for a battery-electric motor vehicle and the energy source 2 be a traction battery of the motor vehicle. Here, the heater 1 comprises a heating element 4 with a temperature-dependent resistance and a regulating unit 5 with a switch 6 and a micro controller 7. Here, the heating element 4 is a PTC thermistor and can be in particular a ceramic PTC thermistor. The microcontroller 7 generates a square-wave signal i.e. PWM-signal of variable width i.e. with a variable duty cycle after the switch 6 closes and opens. By way of this, the current on the heating element 4 is varied and the heating element 4 regulated to the required heating output. The voltage on the heating element 4 is not directly affected by the switch 6 and is constant. The micro controller 7 can additionally read out the current and/or the voltage on the heating element 4. This information can be used for regulating the heating element 4 to the required output and to calculate the resistance R of the heating element 4.

FIG. 2 shows a temperature-resistance characteristic curve of the heating element 4. At temperatures below a transition T_Ü, the heating element 4 exhibits an NTC heating behaviour and above the transition temperature T_Ü a PTC heating behaviour. The transition temperature T_Ü corresponds to a resistance minimum R_MIN. In addition, a threshold temperature T_TH is defined which corresponds to a threshold resistance R_TH. The threshold temperature T_TH is above the transition temperature T_Ü and below a Curie temperature T_CURIE, at which the heating element 4 is physically destroyed.

Here, the regulating unit 5 regulates the heating element 4 maximally to a maximum output which lies at the threshold temperature T_TH and the threshold resistance R_TH. By way of this, the overheating protection of the heating element 4 is realised at the threshold temperature T_TH and not at the Curie temperature T_CURIE. Accordingly, a safe working range I of the heating element 4 is below the threshold temperature T_TH and the threshold resistance R_TH and an unsafe working range II above the threshold temperature T_TH and the threshold resistance R_TH.

In the unsafe working range II, an offset range II-A can be additionally defined in which the temperature and the resistance of the heating element 4 can briefly be without overheating of the heater 1. By contrast, the temperature and the resistance of the heating element 4 must not be in a remaining working range II-B of the unsafe working range II since the overheating of the heater 1 can very probably be not prevented. A division of the unsafe working range II into the working ranges II-A and II-B takes place at a limit temperature T_G which is calculated from the threshold temperature T_TH with an offset. Accordingly, a corresponding limit resistance R_G is calculated from the threshold resistance R_TH with an offset.

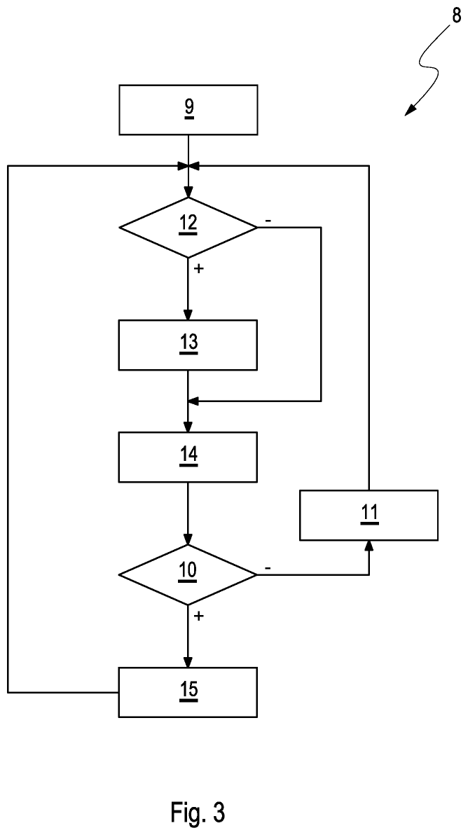

FIG. 3 shows a diagram of a method 8 according to the invention for regulating the heater 1 according to the invention. There, the method 8 is started in an initial step 9 in that for example the heater 1 is switched on. After the initial step 9 the regulating unit 5 proceeds to a check.

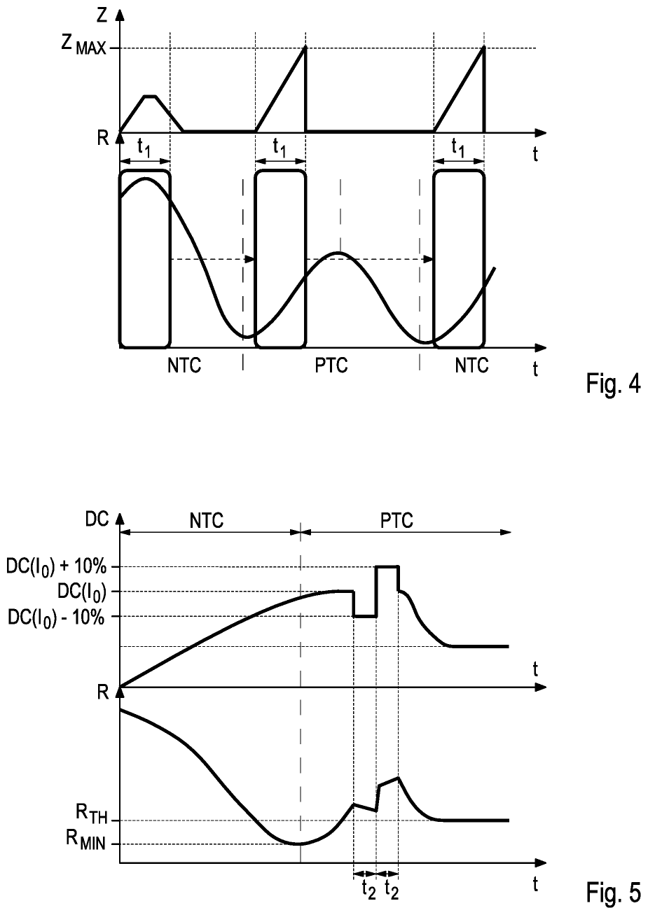

During the check, the regulating unit 5 checks in an establishment step 12 the time profile of the resistance R of the heating element 4. The resistance R is here calculated from the current and the voltage measured on the heating element 4. There, the regulating unit 5 determines a behaviour that can be interpreted as transition between the NTC heating behaviour and the PTC heating behaviour in the heating element 4. When the searched behaviour is present, the regulating unit 5 proceeds to a verification step 13 in which the regulating unit 5 determines the current heating behaviour of the heating element 4. In a following determination step 14, the regulating unit 5, dependent on the current heating behaviour, determines the at least one input parameter for the heating element 4. When the behaviour searched for by the regulating unit 5 is not present, the regulating unit 5, after the establishment step 12, proceeds directly to the determination step 14. The determination step 14 and the verification step 13 are explained in more detail in the following by way of FIG. 4 and FIG. 5.

In the establishment step 12, the regulating unit 5 determines a behaviour which can be interpreted as transition between the NTC heating behaviour and the PTC heating behaviour. Making reference to FIG. 2, the resistance R of the heating element 4 falls to the resistance minimum R_MIN and rises from the resistance minimum R_MIN when the heating element 4 changes out of the NTC heating behaviour into the PTC heating behaviour or from the PTC heating behaviour into the NTC heating behaviour. In the establishment step 12, the regulating unit 5 can determine this behaviour and thereby the transition between the NTC heating behaviour and the PTC heating behaviour. This is explained in more detail in the following by way of FIG. 4.

FIG. 4 shows in the lower diagram the time profile of the resistance R on the heating element 4 and in the upper diagram the profile of a counter Z both based on the measured current values on the heating element 4. There, the heating element 4 is initially heated and proceeds from the NTC heating behaviour into the PTC heating behaviour. In the process, the resistance R falls before the transition and increases again after transition. Thereafter, the heating element 4 is cooled and proceeds out of the PTC heating behaviour into the NTC heating behaviour. The resistance R in the process falls before the transition and increases again after the transition. Here, the regulating unit 5 measures in the establishment step 12 the current of the heating element 4 within a predetermined time window t 1. While measuring the current, the regulating unit 5 increases the counter Z when the currently measured current value is higher than all current values measured before that. Making reference to the upper diagram, the regulating unit 5 establishes the behaviour that is similar to the transition when the counter Z exceeds a counter threshold value Z_MAX.

However, the resistance R of the at least one heating element 4 can also fall and rise conditional on the surroundings and without the transition—for example through a change of the fluid flow. Accordingly, the resistance R in the PTC heating behaviour rises during environmental heating of the heating element 4 and in the NTC heating behaviour during environmental cooling of the heating element 4. In order to exclude environmental errors, the regulating unit 4 verifies in the verification step 13 the heating behaviour that is currently present. This is explained in more detail in the following by way of FIG. 5.

In the following safeguarding step 10 the regulating unit 5 verifies the state of the heating element 4. When the heating element 4 is overheated and the temperature cannot be reduced by reducing of duty cycle of the PWM-signal for the applied current, the regulating unit 5 discontinues the regulating in an interruption step 11 and interrupts the energy supply of the heating element 4 for a defined time interval of for example 30 seconds. In the safeguarding step 10, the heating behaviour of the heating element 4 is also taken into account. In particular, this can prevent the switching off of the heating element 4 during NTC heating behaviour due to the incorrectly detected overheating. When the heating element 4 is not overheated with the current input parameters or when the temperature can be reduced by a normal way, the regulating unit 5 in a following regulating step 15 regulates the heating element with the input parameters. Following the regulating step 15, the regulating unit 5 again proceeds to the establishment step 12.

FIG. 5 shows in the upper diagram a time profile of duty cycle DC of the PWM-signal for current on the heating element 4. In the lower diagram, a time profile of the resistance R on the heating element 4 is shown. The resistance R is calculated from the current measured on the heating element 4. When during the establishment step 12 the behaviour that is similar to the transition was established, the current heating behaviour is determined in the verification step 13. Making reference to the upper diagram, the duty cycle DC of the PWM-signal for an initial current I_0 on the heating element 4 in each case for a time interval t_2 is reduced and increased by 10% each. The duty cycle DC of the PWM-signal for the initial current I_0 is the value currently applied to the heating element 4 at the start of the verification step 13. Making reference to the lower diagram, the resistance R of the heating element 4 also changes with the change of the duty cycle DC of the PWM-signal for the current I_0. The mentioned change of the resistance R is evaluated by the regulating unit 5 by way of a ramp determination.

When the resistance R falls during the reduction of the duty cycle DC of the PWM-signal for the initial current I_0 and rises during the increase of the duty cycle DC of the PWM-signal for the initial current I_0, the regulating unit 5 determines the current heating behaviour as the PTC heating behaviour. This behaviour corresponds to the behaviour of the current on the heating element 4, whereby the current on the heating element 4 rises during the reduction of the duty cycle DC of the PWM-signal for the initial current I_0 and falls during the increase of the duty cycle DC of the PWM-signal for the initial current I_0. When the resistance R during the reduction of the duty cycle DC of the PWM-signal for the initial current I_0 increases and falls during the increase of the duty cycle DC of the PWM-signal for the initial current I_0, the regulating unit determines the current heating behaviour as NTC heating behaviour. This behaviour corresponds to the behaviour of the current on the heating element 4, whereby the current on the heating element 4 falls during the reduction of the duty cycle DC of the PWM-signal for the initial current I_0 and rises during the increase of the duty cycle DC of the PWM-signal for the initial current I_0. Should it not be possible to unambiguously determine the heating behaviour, the regulating unit can repeat the verification step and reduce and increase the duty cycle DC of the PWM-signal for the initial current I_0 for example by 20% in each case.

In FIG. 5, the resistance R falls during the reduction of the duty cycle DC of the PWM-signal for the initial current I_0 and increases upon the increase of the duty cycle DC of the PWM-signal for the initial current I_0. Accordingly, the heating element 4 exhibits the PTC heating behaviour. Making reference to FIG. 3, the at least one input parameter for the heating element 4 is now determined in the determination step 14 dependent on the determined PTC heating behaviour.

The method 8 makes possible the safe regulating of the heater based on the resistance of the heating element 4. By way of this, cost-intensive temperature sensors are no longer required and the costs of the heater can be advantageously reduced.

1. A method for regulating a heater including at least one heating element having a temperature-dependent electrical resistance, the method comprising:
determining, with a regulating unit of the heater, a current heating behaviour of the at least one heating element based on a time profile of the resistance of the at least one heating element with a regulating unit of the heater, the at least one heating element exhibiting (i) an NTC heating behaviour at temperatures below a transition temperature, (ii) a PTC heating behaviour at temperatures above the transition temperature, and (iii) a transition between the NTC heating behaviour and the PTC heating behaviour at the transition temperature and a resistance minimum;
determining, with the regulating unit, at least one input parameter for the at least one heating element based on the current heating behaviour; and
regulating, with the regulating unit, the at least one heating element via the at least one input parameter.

2. The method according to claim 1, wherein regulating the at least one heating element via the at least one input parameter includes adjusting a required heating output when the at least one heating element is exhibiting the PTC heating behaviour.

3. The method according to claim 1, wherein:
regulating the at least one heating element via the at least one input parameter includes regulating the at least one heating element to a maximum output when the at least one heating element is exhibiting the PTC heating behaviour;
the maximum output is defined at a threshold resistance, which correlates to a threshold temperature; and
the threshold temperature is smaller than a Curie temperature of the at least one heating element and greater than the transition temperature.

4. The method according to claim 1, further comprising:
verifying, with the regulating unit, a state of the at least one heating element after checking the time profile; and
discontinuing, with the regulating unit, the regulating of the at least one heating element and interrupting an energy supply of the at least one heating element for a defined time interval when (i) the at least one heating element has a temperature above a threshold temperature and (ii) the temperature cannot be reduced under the threshold temperature by regulating the at least one heating element via the at least one input parameter.

5. The method according to claim 1, wherein:
determining the current heating behaviour of the at least one heating element includes checking, with the regulating unit, the time profile of the resistance of the at least one heating element and searching for a behaviour which can be interpreted as the transition between the NTC heating behaviour and the PTC heating behaviour in the at least one heating element;
when the searched behaviour is present, (i) the method further comprises determining, with the regulating unit, a currently detected heating behaviour of the at least one heating element and (ii) the regulating unit determines the at least one input parameter for the at least one heating element based on the currently detected heating behaviour; and
when the searched behaviour is not present, the regulating unit determines the at least one input parameter for the at least one heating element based on a previously detected heating behaviour.

6. The method according to claim 5, wherein:
checking the time profile of the resistance of the at least one heating element includes measuring a current on the at least one heating element within a predetermined time window with the regulating unit;
measuring the current includes increasing, with the regulating unit, a counter when a currently measured current value is higher than all previously measured current values; and
the method further comprises establishing, with the regulating unit, the current heating behaviour to be interpreted as the transition when the counter exceeds a predetermined counter-threshold value.

7. The method according to claim 6, wherein determining the currently detected heating behaviour includes:
increasing, with the regulating unit, a duty cycle of a PWM-signal for an initial current currently applied to the at least one heating element for a predetermined time interval by a predefined value and sensing a corresponding change of the current of the at least one heating element; and
reducing, with the regulating unit, the duty cycle of the PWM-signal for the initial current currently applied to the at least one heating element for the predetermined time interval by the predefined value and sensing a corresponding change of the current of the at least one heating element.

8. The method according to claim 7, wherein determining the currently detected heating behaviour further includes:
determining, with the regulating unit, that the currently detected heating behaviour is the PTC heating behaviour when (i) increasing the duty cycle increases a resistance calculated from the sensed current and (ii) reducing the duty cycle decreases the resistance calculated from the sensed current; and
determining, with the regulating unit, that the currently detected heating behaviour is the NTC heating behaviour when (i) increasing the duty cycle decreases the resistance calculated from the sensed current and (ii) reducing the duty cycle increases the resistance calculated from the sensed current.

9. The method according to claim 8, further comprising:
repeating, with the regulating unit, the process of determining the currently detected heating behaviour when the regulating unit was unable to determine the currently detected heating behaviour; and
repeating the process of determining the currently detected heating behaviour includes increasing and reducing the duty cycle for the predetermined time interval by a second predefined value which is higher than the predefined value.

10. The method according to claim 8, wherein determining the currently detected heating behaviour further includes determining, with the regulating unit, whether the resistance calculated from the sensed current increases or decreases via a ramp determination.

11. A heater, comprising:
a regulating unit configured to carry out the method according to claim 1; and
at least one heating element having a temperature-dependent electrical resistance;
wherein the at least one heating element exhibits a transition between an NTC heating behaviour and a PTC heating behaviour at a transition temperature and a resistance minimum;
wherein the at least one heating element exhibits the NTC heating behaviour at temperatures below the transition temperature; and
wherein the at least one heating element exhibits the PTC heating behaviour at temperatures above the transition temperature.

12. The method according to claim 1, wherein regulating the at least one heating element via the at least one input parameter includes adjusting the at least one input parameter.

13. The method according to claim 1, wherein:
the at least one heating element has a Curie temperature; and
regulating the at least one heating element via the at least one input parameter includes preventing the at least one heating element from reaching the Curie temperature.

14. The method according to claim 1, wherein the at least one input parameter includes at least one of a current and a voltage.

15. The method according to claim 1, further comprising:
measuring a current on the at least one heating element;
measuring a voltage on the at least one heating element; and
calculating the resistance of the at least one heating element.

16. The method according to claim 5, further comprising, when the searched behaviour is present, determining whether the searched behaviour was caused by an environment of the at least one heating element.

17. The method according to claim 7, wherein the predefined value is 10% of the duty cycle.

18. The method according to claim 8, wherein determining the currently detected heating behaviour further includes determining, with the regulating unit, the resistance minimum of the at least one heating element.

19. The method according to claim 9, wherein the second predefined value is 20% of the duty cycle.

20. The method according to claim 9, wherein the predefined value and the second predefined value are different.
